(19) United States
(12) Patent Application Publication
(10) Pub. No.: US 2020/0410858 A1
(43) Pub. Date: Dec. 31, 2020

(54) REAL-TIME AUDIO AND TEXT GENERATOR

(71) Applicant: NJ TRANSIT Corporation, Newark, NJ (US)

(72) Inventors: John Joseph D'ESPOSITO, Monmouth Beach, NJ (US); Svetlana KRAUSE, Springfield, NJ (US); Jomal A. WILLIAMS, Secaucus, NJ (US)

(73) Assignee: NJ TRANSIT Corporation, Newark, NJ (US)

(21) Appl. No.: 16/915,612

(22) Filed: Jun. 29, 2020

Related U.S. Application Data
(60) Provisional application No. 62/868,427, filed on Jun. 28, 2019.

(51) Int. Cl. G08G 1/127; G10L 13/047; G01C 21/36

(52) U.S. Cl. CPC G08G 1/127; G01C 21/3655; G01C 21/3629; G10L 13/047

(57) ABSTRACT

The real-time audio and text generator described herein provides a system that produces real-time audio and text messages to be delivered to passengers in situ in real-time. All data included as audio and text is dynamically generated. Audio output is delivered in mp3 and way file format. Text base data is delivered as raw text that may be accessed through a RESTful API. Any user device that can support audio streaming and/or RESTful text interfaces can be a consumer of the system.

### CROSS REFERENCE TO RELATED APPLICATIONS

This application claims the benefit of U.S. Patent application No. 62/868,427 filed Jun. 28, 2019 entitled REAL-TIME AUDIO AND TEXT GENERATOR, naming inventors John Joseph D'ESPOSITO, Svetlana KRAUSE and Jomal A. WILLIAMS, which application is incorporated by reference as if fully set forth.

### FIELD OF INVENTION

The present invention is directed to the presentation of real-time audio and/or text to consumers, and more specifically, to a real-time audio and/or text generator.

### BACKGROUND

In order to meet customer service and Americans with Disability Act (ADA) standards, transportation companies need to produce real-time information for passengers. The information needs meet audio and visual display standards set forth by the ADA. Therefore, a need exists for a system that generates real-time audio and text messages to convey information and to be delivered to passengers in situ in real-time.

### SUMMARY

The real-time audio and text generator described herein provides a system that produces real-time audio and text messages to be delivered to passengers in situ in real-time. All data included as audio and text is dynamically generated. Audio output is delivered in mp3 and way file format. Text base data is delivered as raw text that may be accessed through a RESTful API. Any user device that can support audio streaming and/or RESTful text interfaces can be a consumer of the system.

A system and method to provide audio and text generation of alerts based on real-time events occurring within a transportation system including a plurality of vehicles are described. The system and method include a plurality of input devices, a centralized active schedule database that receives inputs from the plurality of input devices, a processor that monitors the centralized active schedule database to detect conditions to trigger announcements, a centralized location database that provides information regarding the location for announcement delivery and the priority of the announcement when queried by the processor, a text-to-speech converter that interacts with the processor to convert the text of an announcement to a digital audio file and store the converted announcement in a file system, a queue delegated by the processor configured to queue the announcement, and an audio and text streaming service interconnected with a streaming client to deliver the announcements to at least one location within the transportation system.

The system and method of providing audio and text generation of alerts based on real-time events occurring within a transportation system including a plurality of vehicles include determining the location, times, schedules and routes within the transportation system via plurality of input devices interconnected with a centralized active schedule database that receives inputs from the plurality of input devices, monitoring the centralized active schedule database to detect conditions to trigger announcements, generating an announcement including the location for announcement delivery and the priority of the announcement via a text-to-speech converter that converts the text of an announcement to a digital audio file and store the converted announcement in a file system, queueing the announcements for delivery, and delivering the announcement to at least one location within the transportation system via an audio and text streaming service interconnected with a streaming client.

The plurality of input devices may include a GPS data input device. The GPS data input device may provide the current location of a vehicle of the plurality of vehicles at the current time. The GPS data input device may include at least one device mounted on the vehicle sent to the centralized database through wireless networks in real-time. The plurality of input devices may include a track circuit. The track circuit may be physical device located within the transportation system. The track circuit may be activated when a vehicle of the plurality of vehicles passes over and captures the vehicles unique identifier. The track circuit may send information to the centralized database through a private network. The plurality of input devices may include at least one real-time data input. The plurality of input devices may include bus location data. The plurality of input devices may provide real-time data about the status of the plurality of vehicles. The plurality of input devices may be used to determine the amount of time a vehicle of the plurality of vehicles is either ahead of or behind in schedule. The triggered announcements may include at least one of audio and text announcements. The processor may monitor at least a plurality of seconds late, last modified time, current status and static data such as scheduled departure time to detect when a vehicle is late. The digital file may be an mp3. The queueing of the announcements may include metadata identifying the priority of the announcement. The priority may vary based on location within the transportation system. The audio and text streaming service may pull the announcement from the queue and receives instructions regarding the queued announcement being pulled from the queue and from the file system. The audio and text streaming service and the streaming client may be formed in a single unit with discrete functionality.

### BRIEF DESCRIPTION OF THE DRAWINGS

A more detailed understanding can be had from the following description, given by way of example in conjunction with the accompanying drawings wherein:

FIG. 1 depicts a transportation system that includes a plurality of buses and a plurality of trains according to the present system;

FIG. 2 illustrates a trip of a train in the system of FIG. 1;

FIG. 3 illustrates a specific audio and text generation system of the present invention;

FIG. 4 illustrates an example of a late vehicle event;

FIG. 5 illustrates a method for use in the system of FIG. 1; and

FIG. 6 illustrates a diagram of an example device in which one or more portions of one or more disclosed examples may be implemented.

### DETAILED DESCRIPTION

The real-time audio and text generator described herein provides a system that produces real-time audio and text messages to be delivered to passengers in situ in real-time. All data included as audio and text is dynamically generated. Audio output is delivered in mp3 and way file format. Text base data is delivered as raw text that may be accessed through a RESTful API. Any user device that can support audio streaming and/or RESTful text interfaces can be a consumer of the system.

The Text to Speech (TTS) audio synthesis for the system is designed to support a TTS subsystem that can generate high quality wav/mp3 formatted audio using one or more voice fonts. TTS works with nearly every personal digital device, including computers, smartphones and tablets. The voice in TTS is computer-generated, and reading speed can be sped up or slowed down. Voice quality varies, but can be continuously be adjusted through phonetic mapping via a lexicon component. Some TTS tools also have a technology called optical character recognition (OCR). OCR allows TTS tools to read text aloud from images.

The system can support any type of transportation, such as rail, light rail, subway, ferry, bus or air, for example.

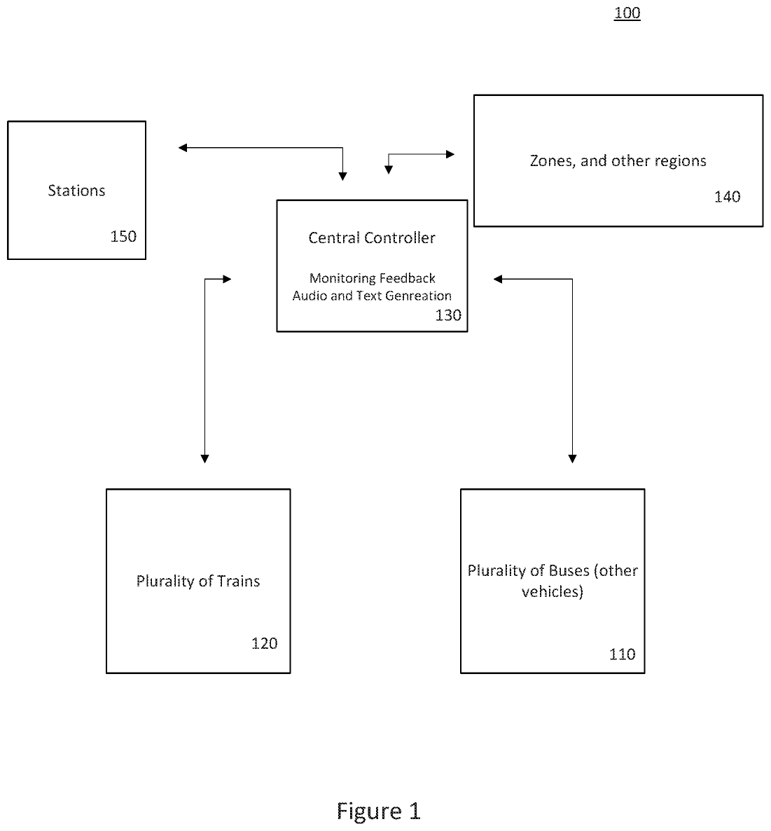

FIG. 1 depicts a transportation system 100 that includes a plurality of buses 110 and a plurality of trains 120 operating between and among a set of stations 150. The system 100 may be designed to be operated at a central location by a central controller 130, or the functions of the central controller 130 at the central location may be divided among a number of different points within the system 100. The central controller 130 functionality may be divided in zones or regions of coverage 140, for example, and the regions of coverage may communicate with one another. Such a divided system may allow for segregation of certain functions within the system 100. The system 100 may include feedback taking the form of line and/or track circuit, GPS data, and other real-time data provided on the vehicles within the present system 100.

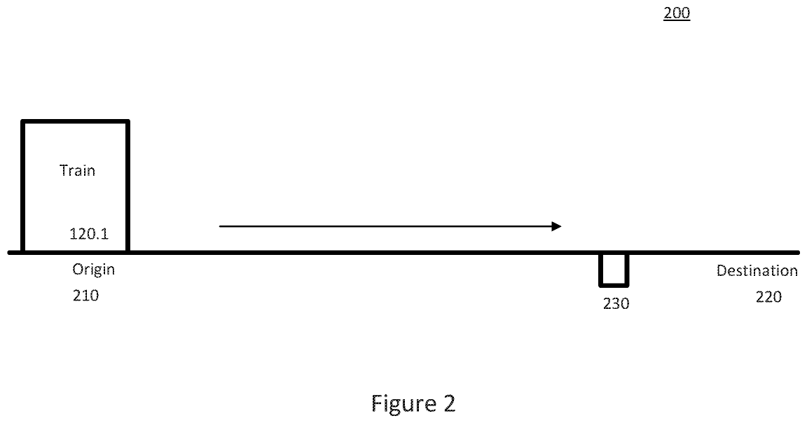

Referring now additionally to FIG. 2, there is illustrated trip 200 of a train 120.1. Train 120.1 may be one of the plurality of trains 120, for example. While a single trip 200 is depicted in FIG. 2, any number of trips may be monitored. The number of trips may be in the hundreds, thousands, or more in a given day.

System 100 relies on real-time data for each specific trip 200. For example, train 120.1 has an origin 210 and destination 220 which defines the trip 200. The trip 200 may be defined before it occurs. That is, the starting point, or origin 210, and time and the ending point, or destination 220, and time are known. Before, during and after the trip 200, real-time data for the trip 200 and current status of the train 120.1 are fed into the system 100. This data is used to monitor the trip 200 determine future information about that trip 200 when the trip 200 reoccurs in the future. The system 100 also uses various types of real-time data to calculate the current status of the trip 200. Real-Time data may be based on many different factors. For instance, train 120.1 may pass over a track circuit 230 having a fixed location on the track. When this event occurs, a signal may be sent from the track circuit 230 to the centralized controller 130 to indicate the train 120.1 passed over the track circuit 230. This signal may include timing information to indicate the exact timing of the train 120.1 interacting with the track circuit 230. Given the fixed location of the track circuit 230, and the time, the real-time data can be used to derive the current state of the trip 200. The system 100 can calculate the current state of the trip 200 based upon one or more real-time events associated with the trip 200 or real-time events associated with trips that affect a given trip. While this example is directed to a single train 120.1 and a single track circuit 230 that is tripped while the train 120.1 proceeds from the origin 210 to the destination 220, this information is collected on each of the plurality of trains 120 and the plurality of buses 110 as the trains and buses perform their daily routes. The track circuit 230 may be prevalent within the system 100, such as placed periodically on tracks and routes to provide constant feedback of the location of the plurality of trains 120 and plurality of buses 110, for example. Additionally other forms of feedback may also be monitored.

System 100 has been described to provide an understanding of where elements within system 100 are located at a given time, when they will arrive at certain locations, and the like (collectively termed “status”). This status generally provides the underlying data for informing users of system 100 of information regarding the current status. Users may be informed by system 100 providing messages regarding the status of elements of the system 100. In addition, this status provides the trigger of when to provide the messages regarding the status.

For example, users at a certain station 150.1 that ride train 120.1 may be provided a message indicating that train 120.1 is on-time when train 120.1 is a certain distance or time from station 150.1. By way of example, this may include when train 120.1 is one, two, three, four or more stops from station 150.1, when train 120.1 is 1, 2, 5, 10 or more minutes from station 150.1. In either case a trigger exists, the number of stops away and/or the time away from station 150.1 to deliver a message based on the status of system 100 that indicates that train 120.1 is on-time for the stop at station 150.1. A trigger based on certain status events of system 100 may be useful for signage that is included within a station, such as station 150.1 in the example. That is the signs in station 150.1 may display a message that train 120.1 is on-time to the signs visible within station 150.1 when train 120.1 is 5 minutes away from station 150.1, for example.

The system 100 supports both automated and on-demand audio and text message generation. Generated messages delivered at a precise moment in time based upon the status of a trip are a critical aspect of any enterprise class communications system. The system 100 uses algorithms to determine exactly when to generate and disseminate audio and text data, such as audio messages, based upon configurable rules and events. System 100 may generate store messages, such as messages that are regularly delivered. Messages may also be provided in a generate and deliver format. The algorithms are extensible to support future data points, status and events. For instance, GPS data may be included to provide another real-time data point. The GPS data of a train 120.1, for example, may be used to determine where in a trip a train 120.1 is located. The addition of GPS data may aid in improving the accuracy and timing of the generation and delivery of automated messages.

For rail-based systems, example message types may include next train, n-minute, late train, track change and canceled train, for example. A next train message may provide an announcement/message that is generated to inform a passenger of the next train to arrive at a location. An n-minute message may include an announcement/message generated to inform a passenger that a specific train 120.1 is arriving in “n” minutes. A late train message may be a repeating announcement/message that informs passengers that a train 120.1 is late. A track change message may include a repeating announcement/message that informs passengers that the original scheduled track for a trip has been changed. This track change message instructs the passenger the new track and may even provide instructions regarding how to access the new track. A cancelled train message may include a repeating announcement/message that informs passengers that a given train has been cancelled.

In addition to automated message generation, system 100 provides a REST based interface that can be used for System-To-System on-demand message generation. As with the messages described herein above, system may generate on-demand, or have pre-generated messages available. The generated messages may be placed in a queue with an associated priority for a specific destination indicated as one of its meta-data elements. The priority is used to sort messages based on priority or need for delivery. For instance, an emergency message type is reserved with a priority of “1.” This priority level may be used to ensure that the emergency message takes precedence over other message types and therefore is presented more quickly or more timely. By way of example, a queue may be created for a particular location within which each of the messages for that location is placed. The queued messages may then be delivered based on requested delivery time after accounting for priority. For instance, a queue may exist to support messages to be disseminated to the “Newark Penn Station” location. The queue can be used/presented in order, with priority given to certain classified messages.

The system 100 supports the generation of audio and text messages to be delivered to various types of locations. Any combination of system wide, line, direction, station, zones and area dispersals may be queued for any message type. A system wide dispersal is an announcement/message that is generated and disseminated to all locations that are supported by the system. For instance, if an emergency announcement should be created and sent to inform all passengers at all locations that a catastrophic event occurred and with instructions on how to proceed. Line dispersal is used as most transportation systems have a concept of a line that represents potential locations/stops along a route in a geographic region. A line type announcement/message is one that is generated and disseminated to an entire line, i.e., all locations on the line. Direction dispersal includes a line or station type announcement/message generated and disseminated to all areas within location that support a specific direction. For instance, a message that should be delivered specifically to areas of locations where “westbound” or “outbound” trains arrive and depart, for example. Station dispersal includes an announcement/message that should be delivered to one or more stations. Zone dispersal includes an announcement/message that should be delivered to one or more zones in one or more stations. Area dispersal includes an announcement/message that should be delivered to one or more areas within in one or more zones in one or more stations

The present invention includes algorithms used to accurately calculate precise moment and time when an announcement/message should be created. These factors in the type of message and the dispersal of the message in order to calculate the timing of the generation and delivery of the message.

The present invention utilizes a lateness triangulation algorithm that is used to accurately determine “lateness” of train/bus through multiple events and data points. This algorithm accounts for multiple circuit reports and feedback points to cascade the lateness of a vehicle, such as a bus. For example, if the bus is late on three stops for 3, 4, and 5 minutes, in a random order, it may be determined that the bus is operating 4 minutes behind schedule.

The present invention provides destination location delivery that enables directing/queueing messages to precise locations and areas/zones within locations as well as system, line and direction, as described hereinabove.

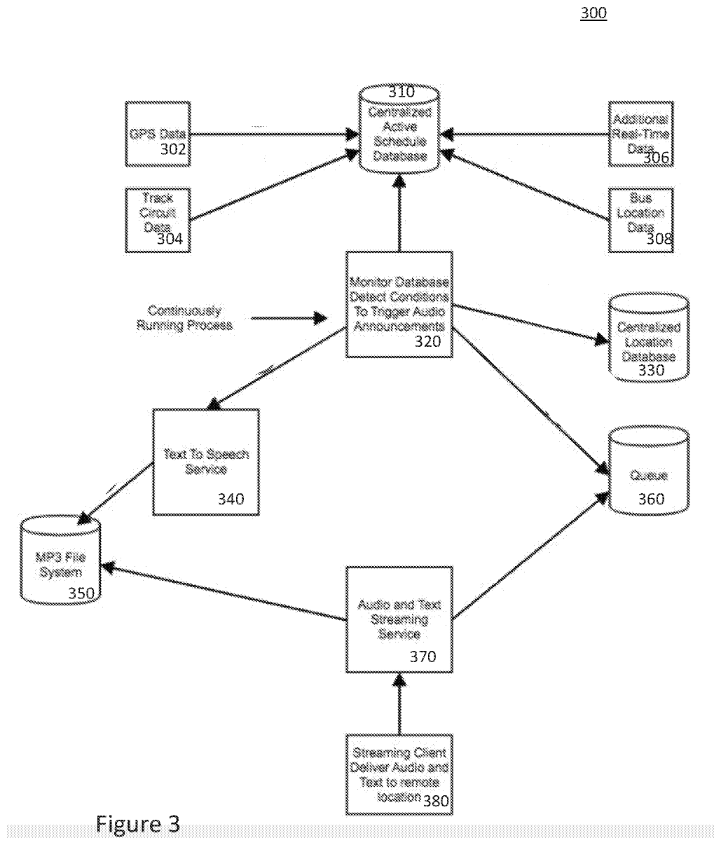

FIG. 3 illustrates a specific audio and text generation system 300 of the present invention. System 300 includes a centralized active schedule database 310. Database 310 receives inputs from GPS data 302, track circuit data 304, additional real-time data 306, and bus location data 308. The GPS data 302 provides the current location of a vehicle at the current time. The GPS data 302 is provided from devices mounted on vehicles sent to a centralized database through wireless networks in real-time fashion. Track circuits 304 are physical devices located at different locations within a rail system. When a vehicle passes over a track circuit 304, the vehicles unique identifier and other information are captured and sent to a centralized database through private networks. The inputs 302, 304, 306, 308 represent a several source systems that continuously provides real-time data about the status of the vehicles while on a trip or run. Track circuit 304, GPS 302 and other data inputs 306, 308 are used to determine the amount of time a vehicle is either a head of or behind in schedule.

A processor 320 monitors the database to detect conditions to trigger announcements, including audio and/or text announcements. The processor 320 represents a centralized process to continuously monitor the data elements of database 310 to attempt to detect conditions that require triggering an announcement. For instance, real-time data such as seconds late, last modified time, current status may be combined with static data such as scheduled departure time to detect when a vehicle is late. Upon detection of a late vehicle, system 300 may begin the process to trigger an announcement, which may be delivered to one or more locations. Processor 320 outputs to a centralized location database 330, a queue 360 and a text-to-speech service 340.

Centralized location database 330 provides information that is needed to determine where announcements need to be sent, or alternatively, the locations that may benefit from receiving the announcement. Centralized location database 330 may provide the priority order of these locations in order to properly queue the messages for delivery from queue 360. In order to gain this information, processor 320 may query the centralized location database 330 to obtain information regarding the locations needing to receive the announcements and the information regarding the queuing of the announcements based on priority.

Processor 320 may interact with a text-to-speech service 340 in order to convert the text of an announcement to a digital audio file, such as an mp3, for example. The text-to-speech service 340 may query a file system 350 that may be a repository of the converted text announcements for delivery within system 300.

Queue 360 may be delegated by processor 320 to queue the announcement with necessary metadata that includes the priority of the announcement. Such a priority may vary based on location, for example. An audio and text streaming service 370 may be interconnected with a streaming client 380 to deliver audio and text to locations. The audio and text streaming service 370 may pull the announcement from the queue 360 and may receive instructs regarding the queued announcement being pulled from the queue 360 from the file system 350.

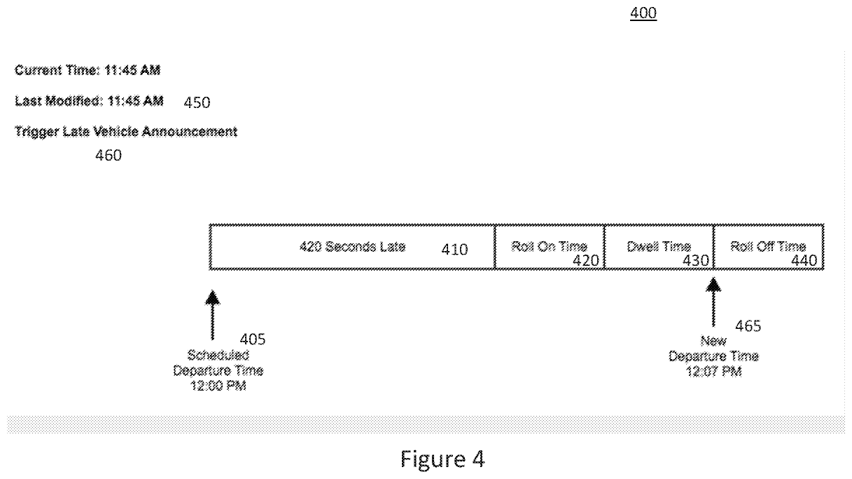

FIG. 4 illustrates an example of a late vehicle event 400. The late vehicle event 400 is initiated with the vehicle having a scheduled departure time 405 of 12:00 pm. The vehicle may include and be referred to as a “train.” It is understood that such a vehicle or “train” refers to any transportation type such as bus, light rail, ferry, for example. The audio generation system of FIG. 3 continuously monitors key data elements derived from real-time line/circuit, GPS and other data integration points. The process continuously executes calculations to detect conditions that require a communication (audio/text base message) to be generated and streamed to one or more destinations as described above. As described in FIG. 3, track circuit, GPS and other data inputs are used to determine the amount of time a vehicle is either a head of or behind in schedule. Referred to as “Seconds Late,” “Seconds Late” 410 is a real-time indicator of the amount of time in seconds a vehicle is either ahead or behind in its schedule in relation to its physical location within is trip or run. “Seconds Late” 410 is dynamic, ever changing and continuously calculated. “Seconds Late” 410 is used in combination of other data elements to determine when a specific time related condition is detected such as when to trigger a late vehicle message, when to trigger a vehicle is now arriving message, and when to trigger the next vehicle will arrive message. The following represents additional data elements used in combination with “Seconds Late” 410. Last Modified Time 450 represents a time stamp that represents the last time the system received an update from an external data source such as a track circuit, GPS device, or other data input. The Dwell Time 430 is the amount of time a vehicle stops and waits at a station to allow passengers to disembark and embark. The Roll On Time 420 is a fixed amount of time in seconds that differs by location and is the amount of time in seconds it takes for a vehicle to completely stop when it enters a location. The Scheduled Departure Time 405 represents a fixed moment in time when the vehicle is expected to depart a location such as a station, terminal or port. The new departure time 465 is calculated using the original scheduled departure time 405 including a seconds late 410, in the example 420 seconds, plus roll on time 420 and dwell time 430.

The Roll Off Time 440 is a fixed amount of time in seconds that differs by location and is the amount of time in seconds it takes for a vehicle to completed exit a location after departure commences. The Expected Arrival Time (not shown) is a continuously calculated time stamp that represents the expected arrival time based upon the “seconds late”, “last modified time” and other data elements. A Scheduled Track/Lane/Slip (not shown) represents the originally scheduled location of where vehicle will stop to drop-off and pick-up passengers, while a Current Scheduled Track/Lane/Slip (not shown) represents the current location where the vehicle will stop to drop-off and pick-up passengers. The Current Status provides a status element that indicates the current disposition of the vehicle as it relates to the trip or run. Indicates if the vehicle is “on-time”, “late”, “early”, “cancelled” or “other.”

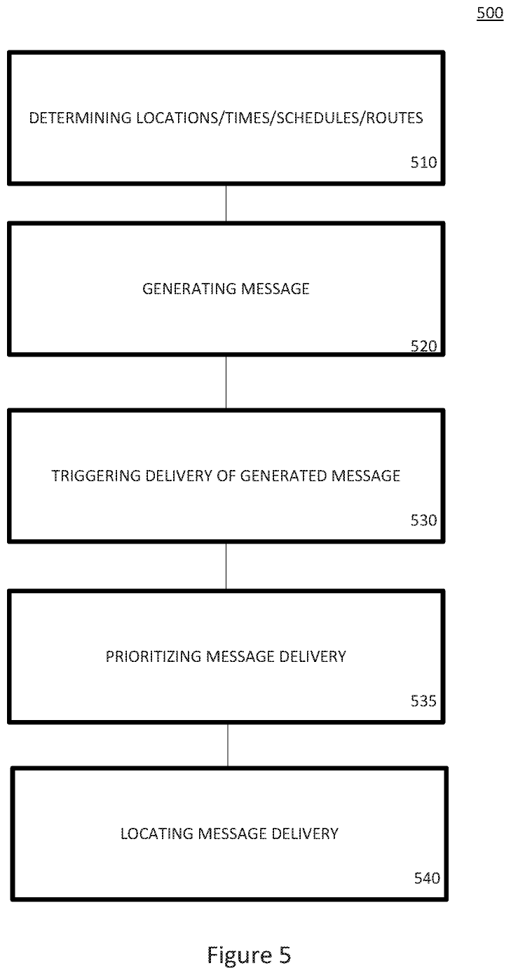

FIG. 5 illustrates a method 500 for use in the system of FIG. 1. Method 500 includes at step 510 determining locations, times schedules and routes of the planes, trains and automobiles of the present system. At step 520, method 500 includes generating a message for delivery based on the determining of step 510. At step 530 triggering the delivery of the message generated in step 520. The triggering may occur based on other facets of system 100 and may be based on priority at step 535 and/or location at step 540.

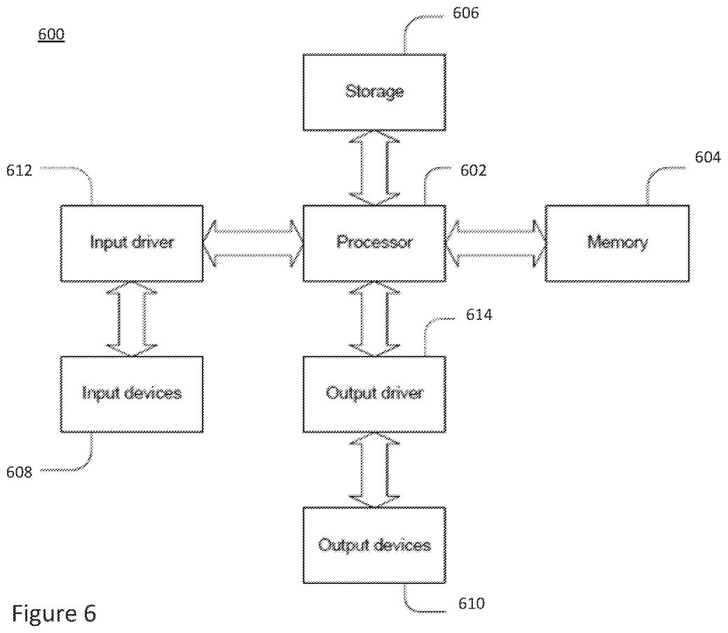

FIG. 6 illustrates a diagram of an example device 600 in which one or more portions of one or more disclosed examples may be implemented. The device 600 may include, for example, a head mounted device, a server, a computer, a gaming device, a handheld device, a set-top box, a television, a mobile phone, or a tablet computer. The device 600 includes a compute node or processor 602, a memory 604, a storage 606, one or more input devices 608, and one or more output devices 610. The device 600 may also optionally include an input driver 612 and an output driver 614. It is understood that the device 600 may include additional components not shown in FIG. 6.

The compute node or processor 602 may include a central processing unit (CPU), a graphics processing unit (GPU), a CPU and GPU located on the same die, or one or more processor cores, wherein each processor core may be a CPU or a GPU. The memory 604 may be located on the same die as the compute node or processor 602, or may be located separately from the compute node or processor 602. The memory 604 may include a volatile or non-volatile memory, for example, random access memory (RAM), dynamic RAM, or a cache.

The storage 606 may include a fixed or removable storage, for example, a hard disk drive, a solid state drive, an optical disk, or a flash drive. The input devices 608 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 610 may include a display, a speaker, a printer, a haptic feedback device, one or more lights, an antenna, or a network connection (e.g., a wireless local area network card for transmission and/or reception of wireless IEEE 802 signals).

The input driver 612 communicates with the compute node or processor 602 and the input devices 608, and permits the compute node or processor 602 to receive input from the input devices 608. The output driver 614 communicates with the compute node or processor 602 and the output devices 610, and permits the processor 602 to send output to the output devices 610. It is noted that the input driver 612 and the output driver 614 are optional components, and that the device 600 will operate in the same manner if the input driver 612 and the output driver 614 are not present.

In general and without limiting embodiments described herein, a computer readable non-transitory medium including instructions which when executed in a processing system cause the processing system to execute a method for load and store allocations at address generation time.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system to provide audio and text generation of alerts based on real-time events occurring within a transportation system including a plurality of vehicles, the system comprising:
a plurality of input devices;
a centralized active schedule database that receives inputs from the plurality of input devices;
a processor that monitors the centralized active schedule database to detect conditions to trigger announcements;
a centralized location database that provides information regarding the location for announcement delivery and the priority of the announcement when queried by the processor;
a text-to-speech converter that interacts with the processor to convert the text of an announcement to a digital audio file and store the converted announcement in a file system;
a queue delegated by the processor configured to queue the announcement; and
an audio and text streaming service interconnected with a streaming client to deliver the announcements to at least one location within the transportation system.

2. The system of claim 1, wherein the plurality of input devices includes a GPS data input device.

3. The system of claim 2, wherein the GPS data input device provides the current location of a vehicle of the plurality of vehicles at the current time.

4. The system of claim 2, wherein the GPS data input device includes at least one device mounted on the vehicle sent to the centralized database through wireless networks in real-time.

5. The system of claim 1, wherein the plurality of input devices includes a track circuit.

6. The system of claim 5, wherein the track circuit is physical device located within the transportation system.

7. The system of claim 5, wherein the track circuit is activated when a vehicle of the plurality of vehicles passes over and captures the vehicles unique identifier.

8. The system of claim 5, wherein the track circuit sends information to the centralized database through a private network.

9. The system of claim 1, wherein the plurality of input devices includes a at least one real-time data input.

10. The system of claim 1, wherein the plurality of input devices includes bus location data.

11. The system of claim 1, wherein the plurality of input devices provide real-time data about the status of the plurality of vehicles.

12. The system of claim 1, wherein the plurality of input devices are used to determine the amount of time a vehicle of the plurality of vehicles is either ahead of or behind in schedule.

13. The system of claim 1, wherein the triggered announcements include at least one of audio and text announcements.

14. The system of claim 1, wherein the processor monitors at least a plurality of seconds late, last modified time, current status and static data such as scheduled departure time to detect when a vehicle is late.

15. The system of claim 1, wherein the digital file is an mp3.

16. The system of claim 1, wherein queueing of the announcements includes metadata identifying the priority of the announcement.

17. The system of claim 1, wherein the priority varies based on location within the transportation system.

18. The system of claim 1, wherein the audio and text streaming service pulls the announcement from the queue and receives instructions regarding the queued announcement being pulled from the queue and from the file system.

19. The system of claim 1 wherein the audio and text streaming service and the streaming client are formed in a single unit with discrete functionality.

20. A method of providing audio and text generation of alerts based on real-time events occurring within a transportation system including a plurality of vehicles, the method comprising:
determining the location, times, schedules and routes within the transportation system via plurality of input devices interconnected with a centralized active schedule database that receives inputs from the plurality of input devices;
monitoring the centralized active schedule database to detect conditions to trigger announcements;
generating an announcement including the location for announcement delivery and the priority of the announcement via a text-to-speech converter that converts the text of an announcement to a digital audio file and store the converted announcement in a file system;
queueing the announcements for delivery; and
delivering the announcement to at least one location within the transportation system via an audio and text streaming service interconnected with a streaming client.
